(19) United States
(12) Patent Application Publication
(10) Pub. No.: US 2014/0337718 A1
(43) Pub. Date: Nov. 13, 2014

(54) GRAPHICAL MARKING TO INDICATE EDITED DATA

(71) Applicant: INTERNATIONAL BUSINESS MACHINES CORPORATION, Armonk, NY (US)

(72) Inventors: Laura M. Bostian, Niskayuna, NY (US); Cheryl D. Loughlin, Poughkeepsie, NY (US)

(73) Assignee: International Business Machines Corporation, Armonk, NY (US)

(21) Appl. No.: 13/888,529

(22) Filed: May 7, 2013

(51) Int. Cl. G06F 17/24

(52) U.S. Cl. CPC G06F 17/24
USPC 715/255

(57) ABSTRACT

A method and system to indicate edited cells during an editing session are described. The method includes displaying a plurality of cells, of the plurality of cells being editable by a user. The method also includes identifying an edited cell of the plurality of cells as a cell in which an edit was done during the editing session, and displaying an indicator in the edited cell, the indicator being automatically generated by the processor based on the edit, wherein the indicator is automatically removed from the edited cell when the editing session is ended.

### BACKGROUND

The present invention relates to editing dynamic fields, and more specifically, to a visual indication of edited dynamic fields.

Many applications allow a user in one or more capacities to edit fields (cells). A user interface may facilitate editing cells in a table, form, property sheet or other format. For example, a vendor who ships products to many customers may use a mailing service application that allows input of an address, number of packages, and other information related to each shipment identifier for each shipment. The information may be displayed as a table, for example, with dynamic (editable) cells. When the exemplary table includes numerous entries and a user (vendor) edits many of the cells of the table, keeping track of the edited fields may become difficult and cumbersome.

### SUMMARY

According to one embodiment of the present invention, a method of indicating edited cells to the editor during an editing session includes displaying, on a display device, a plurality of cells, some or all of the plurality of cells being editable by a user; identifying, using a processor, an edited cell of the plurality of cells as a cell in which an edit was done during the editing session; and displaying, on the display device, an indicator in the edited cell, the indicator being automatically generated by the processor based on the edit, wherein the indicator is automatically removed from the edited cell when the editing session is ended, or the edits are otherwise retained or discarded.

According to another embodiment of the invention, a system to indicate edited cells during an editing session includes a display device to display a plurality of cells, some or all of the plurality of cells being editable by a user via a user interface; and a processor configured to identify an edited cell among the plurality of cells as a cell in which an edit was done during the editing session, to automatically generate an indicator for display in the edited cell, and to automatically remove the indicator from display in the edited cell when the editing session is ended, or the edits are otherwise retained or discarded.

According to another embodiment of the invention, a computer program product to dynamically display a presentation of a time duration comprises a computer readable storage medium having program code embodied therewith that is readable and executable by a processor to perform a method. The method includes displaying, on a display device, a plurality of cells, some or all of the plurality of cells being editable by a user; identifying an edited cell of the plurality of cells as a cell in which an edit was done during the editing session; and displaying, on the display device, an indicator in the edited cell, the indicator being automatically generated by the processor based on the edit, wherein the indicator is automatically removed from the edited cell when the editing session is ended, or the edits are otherwise retained or discarded.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates an exemplary display according to an embodiment of the invention;

FIG. 2 illustrates a display according to embodiments of the invention;

FIG. 3 illustrates cell history according to embodiments of the invention;

FIG. 4 is a process flow of an exemplary method of indicating edited cells during an editing session according to an embodiment of the invention; and

FIG. 5 is a block diagram of a system to indicate edited cells during an editing session according to an embodiment of the invention.

### DETAILED DESCRIPTION

As noted above, keeping track of which edits, out of many edits to a table with numerous entries, were completed can become an onerous task. Embodiments of the system and method described herein relate to displaying an identifier for edited cells until the edits are incorporated or discarded. The identifier provides a clear visual cue and facilitates easy inspection of whether all needed edits were completed.

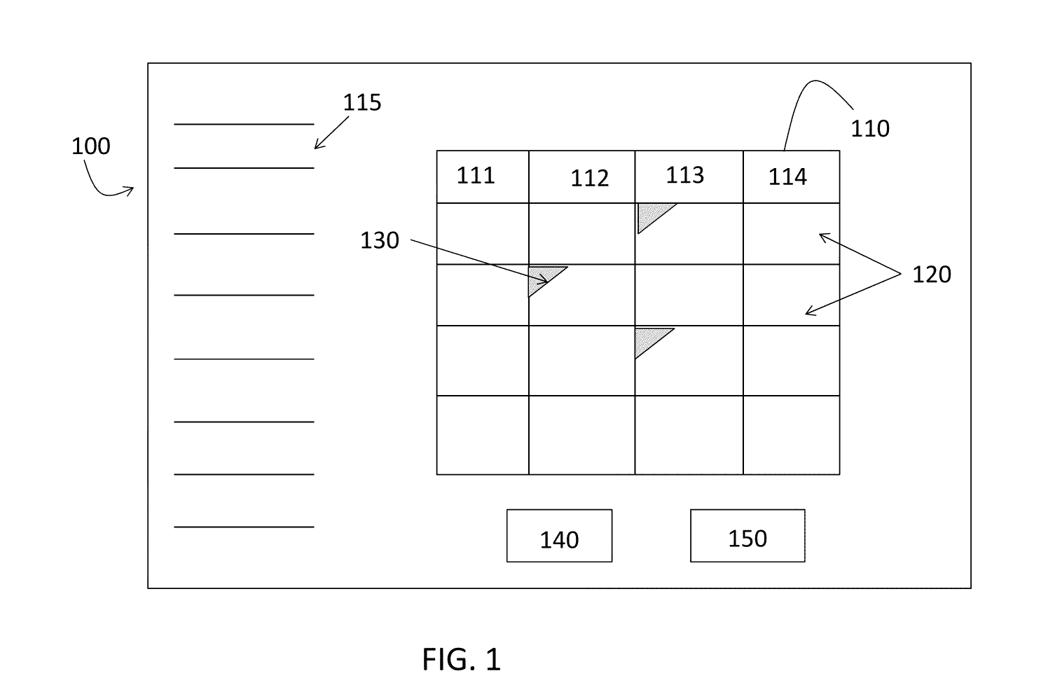

FIG. 1 illustrates an exemplary display 100 according to an embodiment of the invention. The display 100 includes a table 110 and may include other content 115 (e.g., navigation options, actions, links) While a table 110 is used for explanatory purposes, the display 100 may include any grouping of cells 120 (e.g., form fields) that may be edited through a user interface. In the example described herein, the table 110 including several cells 120 details shipment information entered by a vendor shipping merchandise as mentioned above, for example. For example, the column 111 may include the shipment identifier for each shipment. The column 112 may include the address associated with each shipment identifier. The column 113 may include the number of packages, and the column 114 may include the names of those authorized to receive the shipment associated with the shipment identifier. This table 110, when finalized, may be provided to or shared with other interested parties (e.g., a mailing service that would use the information to make deliveries). After the vendor takes orders and sets up the table 110 for an upcoming shipment of merchandise, some of the information in the cells 120 may be found to be inaccurate or may need to be changed due to customer changes. When the table 110 shown in FIG. 1 is imagined on a much larger scale, it becomes apparent that changes made to several cells 120 of the table 110 become difficult to track in an editing session. An editing session continues until an action is performed to incorporate the edits or discard them. FIG. 1 shows exemplary save 140 or cancel 150 buttons. In alternate embodiments, actions (e.g., “OK,” “Apply,” “Reset”) that incorporate or discard the edits in one form or another may be available through the user interface as buttons, pull-down menu items, and the like. For example, selecting “Reset” may discard all the previous edits and let the user initiate another editing session while selection “Cancel” may not only discard the previous edits but also close the user interface.

According to one or more embodiments of the present invention, an identifier 130 is automatically shown in each cell 120 in which an edit is made. This identifier 130 provides a visual indication of edits completed during the editing session. According to one embodiment, the identifier 130 is displayed even if the edit resulted in retyping the existing information. Although shown as a triangular shape at the corner of the cell 120 in FIG. 1 for explanatory purposes, the identifier 130 is not limited to any particular shape, size, or location within the cell 120 and may additionally include a color and/or pattern to highlight the associated cell 120 as an edited cell 120. Once the edits during an editing session are discarded or incorporated, the identifier 130 no longer appears in any cells 120 (it is automatically removed) and a new editing session may be initiated. If the user interface is closed upon incorporating/discarding, the new editing session is initiated by returning to the user interface. If edits are incorporated/discarded while the user interface is still open, then any subsequent edit initiates the next editing session. The identifier 130 is a user interaction feature rather than a document editing feature such that the identifier 130 is automatically provided for the user's benefit rather than being an additional document editing feature that requires user intervention for its use.

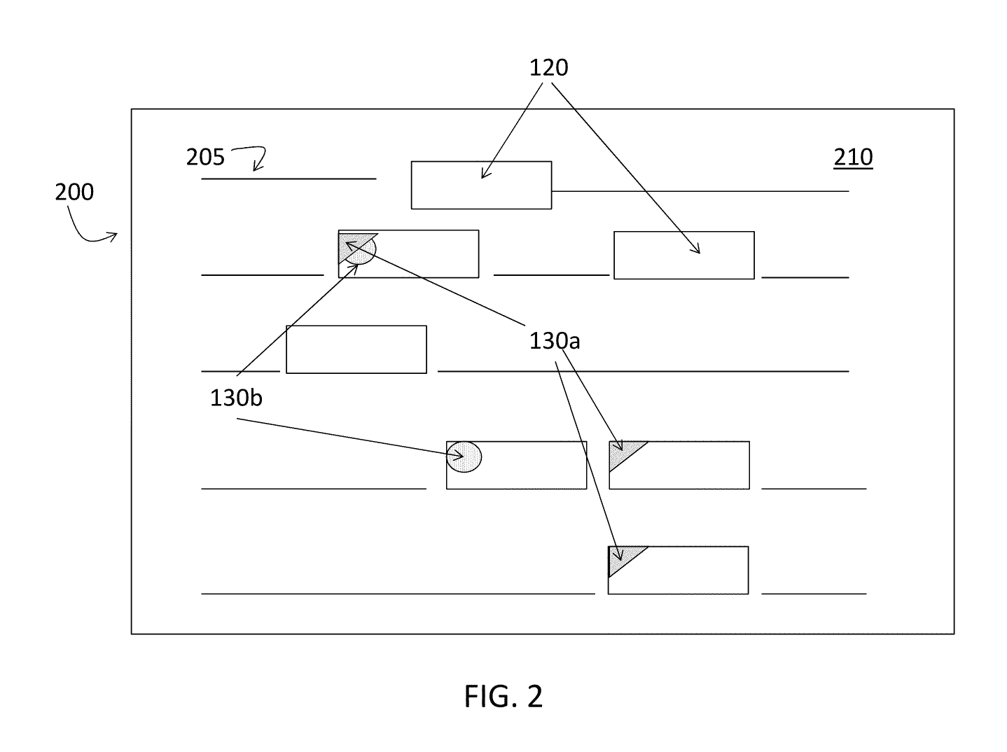

FIG. 2 illustrates a display 200 according to embodiments of the invention. Specifically, FIG. 2 illustrates an embodiment involving multiple editors. According to one embodiment, when multiple editors attempt to access the cells simultaneously, the first editor to begin the editing session will be able to lock out any additional editors (the lockout may be automatic, as well). In this case, the display 100 for the first editor will be no different than the one discussed with reference to FIG. 1. In accordance with another embodiment, each editor sees her or his own version of the user interface, essentially unaware of the other editor(s) or at least their edits, and a backend server synchronizes the edits of the two or more editors. For example, the backend server may retain the most recently applied edit to a given cell 120. In this case, as well, each editor will see a display 100 like the one discussed with reference to FIG. 1.

The embodiment shown in FIG. 2 relates to simultaneous edits of the same cells 120. In alternate embodiments, each editor sees that another editor (or editors) is editing a cell 120 or is additionally able to see the edits of the other one or more editors. The specific example shown in FIG. 2 is of a display 200 of a user interface including a fillable form 210 with editable cells 120 and other content 205 (e.g., text, links). The example illustrated by FIG. 2 involves two editors simultaneously editing the cells 120 of the form 210, but in alternate embodiments, more than two editors may simultaneously edit the cells 120 of the form 210. In the exemplary display 200, two different identifiers 130 are used to indicate the edits made by each editor. For example, when one editor edits a cell 120, a triangular shape may appear in the cell 120 as the identifier 130a, and when the other editor edits a cell 120, a circular shape may appear in the cell 120 as the identifier 130b. Alternative arrangements and displays of the identifiers 130 are contemplated. While some examples are provided here, these examples are not intended to be limiting. The identifiers 130a, 130b may be the same shape or two different shapes other than the ones shown in FIG. 2. The placement of one or both of the identifiers 130 may differ from what is shown in FIG. 2. Identifiers 130 may be numbered or otherwise labeled to denote which editors are editing the cells 120. The display 200 may be different for each editor. For example, assuming the two identifiers 130a, 130b shown in FIG. 2, the identifier 130 associated with the other editor may appear as a “ghost image.” That is, a first editor viewing the display 200 and having his or her edits indicated by identifier 130a may see identifier 130b with less resolution than his or her own identifier 130a. The opposite would be true for the editor associated with identifier 130b. An additional feature may be included according to embodiments of the invention such that the value put in a cell 120 by another editor (in addition to the identifier indicating another editor's edit) is visible. For example, the first editor may see identifier 130b indicating an edit by another editor and may then be able to see the value entered by the other editor in the cell 120 showing identifier 130b. The value may be accessible based on a selection of a button, pull-down menu item, or mouse button option, for example. When such simultaneous editing is facilitated, the ultimate value of a given cell 120 may be determined in a number of ways. The last incorporated value for a cell 120 may be retained, regardless of which editor incorporated that value. There may be a hierarchy among editors such that, if the same cell 120 is edited by more than one editor, the change (made and incorporated rather than discarded) by the editor who has the highest ranking within the hierarchy would be retained. In alternate embodiments, an agreement may be necessary for one of the changes to ultimately be incorporated, and dialogue among the editors may be facilitated to bring about that agreement. Again, the examples provided herein are intended to be illustrative rather than limiting.

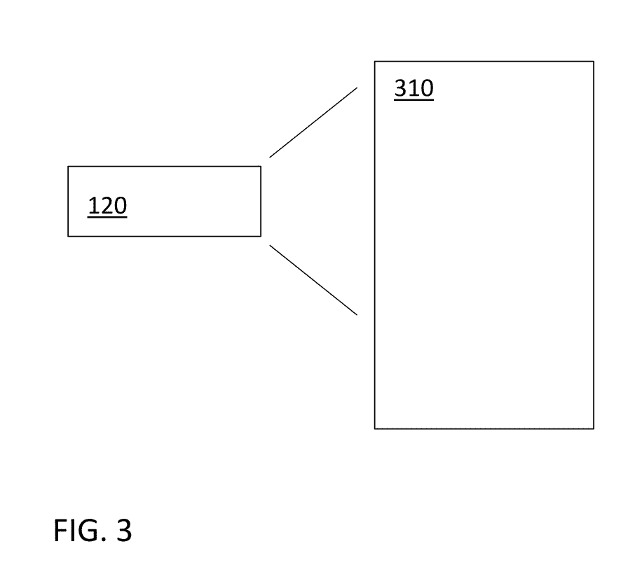

FIG. 3 illustrates cell 120 history 310 according to embodiments of the invention. Because a given cell 120 may have been edited multiple times, each of the values incorporated for the cell 120 in the past may be of interest. According to one example, the history 310 may appear as a pop-up window within the user interface display based on a selection of a button, pull-down menu item, or mouse button option. The cell 120 shown in FIG. 3 may be one of a number of cells 120 in a form or a table, for example. The history 310 may include information in addition to previous values for the cell 120 to which the history 310 corresponds. For example, a time of the input of the value and/or incorporation of the value may be included. The identity of the editor who incorporated the value may be included. Other additional information is contemplated, and the examples provided herein are not intended to be limiting.

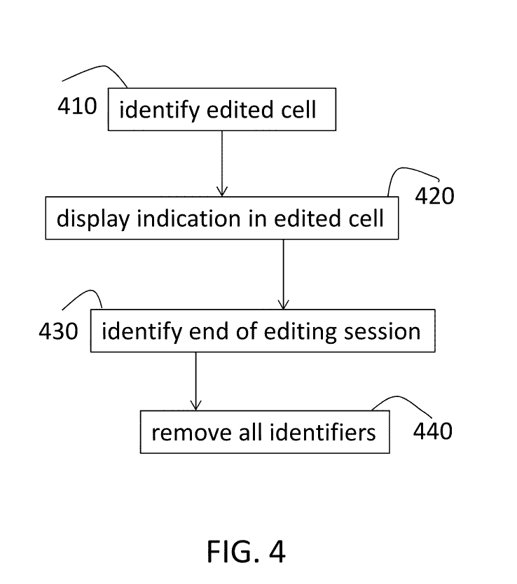

FIG. 4 is a process flow of an exemplary method of indicating edited cells 120 during an editing session according to an embodiment of the invention. At block 410, the method includes identifying an edited cell based on a user input within the cell 120. At block 420, displaying an indication in the edited cell 120 includes providing an identifier 130 as shown in FIG. 1, for example. In alternate embodiments, the indication may include a change in color or pattern of an identifier 130. The identifier 130 may have a different shape than the one shown in FIG. 1. At block 430, identifying an end of an editing session may be based on the user selecting save 140 or cancel 150, for example. As noted above, other actions presented as buttons, pull-down menu items, and the like may also be selected to incorporate or discard edits and end an editing session. The end of an editing session may or may not include the closing of the user interface used to make the edits. At block 440, the method includes removing all the identifiers 130 generated during the editing session based on identifying the end of the editing session at block 430. Accordingly, each editing session generates identifiers 130 anew based on the editing done during that editing session. In addition, no user intervention or additional step (beyond editing the content of the cells 120) is involved in generating or removing the identifiers 130, because both the generation and removal of identifiers 130 is automatically done based on the editing.

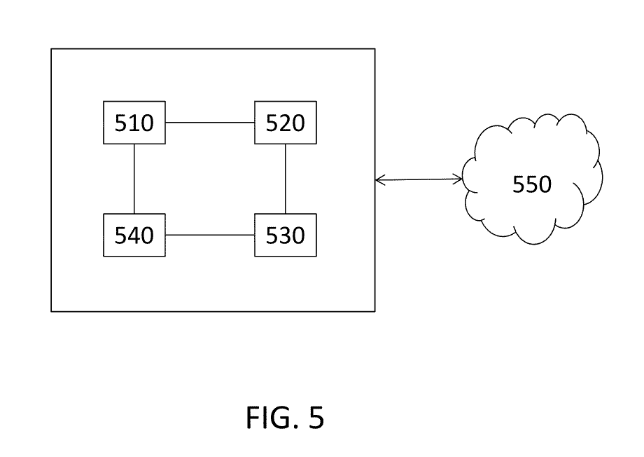

FIG. 5 is a block diagram of a system to indicate edited cells 120 during an editing session according to an embodiment of the invention. Embodiments discussed above regarding multiple editors may employ multiple systems in communication with each other or a single system receiving inputs from multiple editors. The system includes one or more processors 510 and one or more memory devices 520. The system also includes an input interface 530 and an output interface 540. The processor 510 generates identifiers 130 (and removes identifiers 130), as discussed above, according to instructions stored in the memory device 520. The processor 510 output may also be based on input (editing session information) received via a network 550 (wireless network or other connection). That is, a user remote to the system may edit cells 120 that are stored in the memory device 520 of the system or in another system accessible via the network 550. Thus, the processor 510 may receive indications of the user input (edits, selection of save 140 or cancel 150 buttons or other action that incorporates or discards edits) and output a location (cell 120) for display or removal of the identifier 130. The processor 510 outputs a display or data indicating whether and where identifiers 130 should be displayed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagram depicted herein is just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of indicating edited cells during an editing session, the method comprising:
displaying, on a display device, a plurality of cells, each of the plurality of cells being editable by a user;
identifying, using a processor, an edited cell of the plurality of cells as a cell in which an edit was done during the editing session; and
displaying, on the display device, an indicator in the edited cell, the indicator being automatically generated by the processor based on the edit, wherein the indicator is automatically removed from the edited cell when the editing session is ended.

2. The method according to claim 1, further comprising ending the editing session based on a user selection of an action to incorporate or discard all edits made during the editing session.

3. The method according to claim 1, wherein the displaying the indicator includes displaying a shape in the edited cell.

4. The method according to claim 1, wherein the identifying the edited cell includes identifying every cell of the plurality of cells in which an edit was done during the editing session.

5. The method according to claim 4, wherein the displaying the indicator includes displaying the indicator in every cell in which an edit was done during the editing session.

6. The method according to claim 1, wherein the edited cell is edited by a first editor and the method further comprises identifying a second edited cell as a cell edited by a second user during a second editing session and displaying, on the display device, a second indicator in the second edited cell.

7. The method according to claim 1, further comprising displaying, based on a user selection of a cell, a history of values incorporated for the cell in previous editing sessions.

8. A system to indicate edited cells during an editing session, the system comprising:
a display device to display a plurality of cells, each of the plurality of cells being editable by a user via a user interface; and
a processor configured to identify an edited cell among the plurality of cells as a cell in which an edit was done during the editing session, to automatically generate an indicator for display in the edited cell, and to automatically remove the indicator from display in the edited cell when the editing session is ended.

9. The system according to claim 8, the processor further configured to identify when the editing session is ended based on a user selection, through the user interface, of an action to incorporate or discard all edits made during the editing session.

10. The system according to claim 8, wherein the processor generates the indicator as a shape within the edited cell.

11. The system according to claim 8, wherein the processor identifies every cell of the plurality of cells in which an edit was done during the editing session.

12. The system according to claim 11, wherein the processor generates the indicator for display in every cell in which an edit was done during the editing session.

13. The system according to claim 8, wherein the edited cell is edited by a first editor, the processor is further configured to identify a second edited cell edited by a second user during a second editing session, and the display device displays a second indicator in the second edited cell.

14. The system according to claim 8, wherein, based on a user selection of a cell through the user interface, the display device displays a history of values incorporated for the cell in previous editing sessions.

15. A computer program product to indicate edited cells during an editing session, the computer program product comprising a computer readable storage medium having program code embodied therewith, the program code being readable and executable by a processor to perform a method comprising:
displaying, on a display device, a plurality of cells, each of the plurality of cells being editable by a user;
identifying an edited cell of the plurality of cells as a cell in which an edit was done during the editing session; and
displaying, on the display device, an indicator in the edited cell, the indicator being automatically generated by the processor based on the edit, wherein the indicator is automatically removed from the edited cell when the editing session is ended.

16. The computer program product according to claim 15, wherein the method further comprises ending the editing session based on a user selection.

17. The computer program product according to claim 16, wherein the ending the editing session is based on a user selection of an action to incorporate or discard all edits made during the editing session.

18. The computer program product according to claim 15, wherein the displaying the indicator includes displaying a shape in the edited cell.

19. The computer program product according to claim 15, wherein the identifying the edited cell includes identifying every cell of the plurality of cells in which an edit was done during the editing session.

20. The computer program product according to claim 19, wherein the displaying the indicator includes displaying the indicator in every cell in which an edit was done during the editing session.
